(19) United States
(12) Patent Application Publication
(10) Pub. No.: US 2007/0255576 A1
(43) Pub. Date: Nov. 1, 2007

(54) Service providing an electronic market for the distribution of promotional material using software installation packages

(75) Inventor: James Patterson, San Francisco, CA (US)

Correspondence Address: PATENT DEPARTMENT;MACROVISION CORPORATION, 2830 DE LA CRUZ BLVD., SANTA CLARA, CA, 95050, US

(73) Assignee: Macrovision Corporation

(21) Appl. No.: 11/411,631

(22) Filed: Apr. 26, 2006

(51) Int. Cl. G06Q 10/00; G06Q 30/00

(52) U.S. Cl. 705/1

(57) ABSTRACT

An exchange server communicates with advertiser, publisher, and customer computers over the Internet through cooperative software to provide an electronic market for the distribution of promotional material using installation packages for installing publisher software applications on the customer computers. By interfacing with the exchange server through the cooperative software, publishers can offer to distribute other registered parties' promotions to the publishers' customers, for specified bounties and under specified constraints, using installation packages for installing their applications on their customers' computers. Conversely, the publishers or non-publishing advertisers can accept other publishers' similar offers to promote their own products or services. The exchange server not only provides a marketplace for publishers and non-publishing advertisers to meet to make such arrangements, it also may perform accounting services for multiple fixed or custom bounty arrangements, and it may perform, or ensure through third party testing, certain certification services for the parties.

### FIELD OF THE INVENTION

The present invention generally relates to the use of software installation packages for distributing promotional material and in particular, to a service and corresponding system for providing an electronic market for the distribution of promotional material using software installation packages.

### BACKGROUND OF THE INVENTION

Software installers allow users to securely and easily install and/or update software on their computers. Some installers are specifically configured to install the files that they contain, while others are general-purpose and work by reading the contents of the software package to be installed.

A currently popular format for Microsoft® Windows® is the MSI installation package, which is installed by the Microsoft® Windows® Installer. Companies making tools for creating installers for Windows® include InstallShield (now part of Macrovision Corporation), SetupBuilder, Wise, ScriptLogic (formerly MaSal Solutions), InstallAware, BitRock and OnDemand. Most of these tools can create MSI packages as well as their own proprietary executables. Analogous packaging applications and standard package formats exist for other software platforms, such as RPM for Linux and PKG for Solaris.

To generate additional revenue, publishers of popular software applications may allow less popular software applications of other vendors to be included in or bundled with their installation packages for a fee in order to distribute the less popular applications. As an example, FIG. 1 illustrates a packaging program 30 which generates an installation package 40 for installing host application modules 10 and payload application modules 20 on a user computer. Although the installation package 40 in this example is a Setup.exe file, as previously described, it may also be an MSI installation package installable by the Microsoft® Windows® Installer.

When installing the host application modules 10 on his or her computer, the user is generally given the option in this example to also install the payload application modules 20. For example, FIG. 2 illustrates a snap shot of a computer screen 41 generated by the installation executable 40 during the installation process which provides such an install option to the user. In a first area 42 of the computer screen 41 is a description of the software application or computer program that may be installed. In a second area 44 of the computer screen 41 is an installment agreement stating, for example, that by installing the program, the user agrees to the terms of use and privacy policy of its publisher, which can be viewed by clicking respectively on buttons 45 and 46. Clicking on the install application button or checkbox 43 then initiates installment of the payload application modules 20, and confirms acceptance of the installation agreement according to its terms.

Although the packaging of bundled application software is clearly beneficial for both the publisher of the host application (as an additional revenue source) as well as the publisher of the payload application (for promotion and distribution purposes), there are significant obstacles preventing widespread and efficient use of this business model. First of all, it is a very time consuming and difficult process for the parties to find each other and negotiate a deal. It is especially difficult for smaller publishers to gain entry to such arrangements with large publishers since they may not be well known. Because the process is not automated, the effort required to structure and transact each individual agreement may outweigh its benefit to either party.

Secondly, only primitive fee arrangements are believed to be currently available with limited opportunity for each party to audit revenue generating or cost incurring activity performed by the other party. For example, if fees are paid for each delivery of an installation package with bundled payload application software, the payload application publisher may have no alternative but to trust the host application publisher as to the number of installation packages generated and delivered to users. On the other hand, if fees are paid for each conversion from a trial copy installed through the payload application software to a fully licensed copy, then the host application publisher may have no alternative but to trust the payload application publisher as to the number of such conversions.

Thirdly, since installation packages may continue to reside on a user computer or network server for a long period of time, or even be shared between computers and users, a payload application publisher may benefit from a later installation of its bundled software even though the business relationship with the host application publisher has ended. Additionally, even though the business relationship may be continuing, the version of the bundled software may be out of date. In either case, the continuing availability and transferability of the installation package may result in either a windfall or detriment to one or the other of the parties.

### OBJECTS AND SUMMARY OF THE INVENTION

Accordingly, one object of one or more aspects of the present invention is a service which provides an efficient electronic market for the distribution of promotional material using a Software Installation System including software installers, installation packages, and packaging programs.

Another object of one or more aspects of the present invention is a method and system for providing a market for the distribution of promotional material using installation packages, which minimizes the time spent by participants in identifying and negotiating with contracting parties.

Another object of one or more aspects of the present invention is a method and system for providing a market for the distribution of promotional material using installation packages, which provides flexibility in bounty or fee structures.

Another object of one or more aspects of the present invention is a method and system for providing a market for the distribution of promotional material using installation packages, which provides opportunities to update and/or change the promotional material being distributed using a Software Installation System.

Yet another object of one or more aspects of the present invention is a method and system for providing a market for the distribution of promotional material using installation packages, which provides accounting, collections and/or payment services for participating parties.

Still another object of one or more aspects of the present invention is a method and system for providing a market for the distribution of promotional material using installation packages, which enables certification of participants and participating applications.

These and additional objects are accomplished by the various aspects of the present invention, wherein briefly stated, one aspect is a method for providing a marketplace in which publishers of host applications and promoters of promotions arrange for distribution of the promotions using installation packages for installing the host applications, comprising: receiving information of bounties to be paid by the promoters for distribution of the promotions using the installation packages; providing at least a portion of the information of bounties to one or more of the publishers; and receiving from at least one of the one or more of the publishers, an indication of one or more of the promotions that the at least one of the one or more of the publishers is willing to allow to be distributed using the installation packages of the host applications for installing the at least one of the one or more of the publishers.

Another aspect is a method for providing a marketplace in which publishers of host applications and promoters of promotions arrange for distribution of the promotions using installation packages for installing the host applications, comprising: providing a packaging program to a publisher for generating the installation packages for installing the host application of the publisher on customer computers; communicating with the packaging program to provide bounty information to the publisher payable by promoters to the publisher for distributing promotions of the promoters in the installation packages; communicating with the packaging program to receive an indication from the publisher indicating a selection of one or more of the promoters; and communicating with the packaging program to provide corresponding promotions of the one or more promoters to the publisher for distribution in the installation packages.

Another aspect is a method for providing a marketplace in which publishers of host applications and promoters of promotions arrange for distribution of the promotions using installation packages for installing the host applications, comprising: receiving information of a bounty triggering event for a promotion from an installer for installing a host application on a customer computer from contents of an installation package; and updating accounts for a publisher of the host application and a promoter of the promotion to reflect a bounty corresponding to the bounty triggering event.

Another aspect is a method for providing a marketplace in which publishers of host applications and promoters of promotions arrange for distribution of the promotions using installation packages for installing the host applications, comprising: receiving information of a promotion associated with an installation package from an installer during a process of installing a host application using the installation package; determining whether the promotion is to be replaced with a different promotion; and providing the different promotion to the installer if the promotion is to be replaced, or providing an indication to the installer that the promotion is to be promoted if the promotion is not to be replaced.

Another aspect is a method for providing a marketplace in which publishers of host applications and promoters of promotions arrange for distribution of the promotions using installation packages for installing the host applications, comprising: receiving an indication that a trial version of a payload application is to be distributed using installation packages for host applications of host publishers; receiving bounty information indicating what a payload publisher of the payload application is willing to pay to the host publishers to distribute the trial version of the payload application using the installation packages; and transmitting the bounty information to an exchange server accessible to the host publishers so that individual of the host publishers may agree to distribute the trial version of the payload application in the installation packages to their customers.

Another aspect is a method for providing a marketplace in which publishers of host applications and promoters of promotions arrange for distribution of the promotions using installation packages for installing the host applications, comprising: receiving an indication that a host publisher of a host application agrees to promote payload applications of payload publishers using installation packages for installing the host application on customer computers; and receiving bounty information from an exchange server accessible to the host publisher and the payload publishers, indicating what the payload publishers are willing to pay to have their respective payload applications promoted using the installation packages.

Yet another aspect is a method for providing a marketplace in which publishers of host applications and promoters of promotions arrange for distribution of the promotions using installation packages for installing the host applications, comprising: finding a promotion in an installation package of a host application during an installation process of the host application on a customer computer; connecting with an exchange server and transmitting information identifying the host application and the promotion to the exchange server; and receiving an indication to promote the promotion or a new promotion from the exchange server.

Still another aspect is a method for providing a marketplace in which publishers of host applications and promoters of promotions arrange for distribution of the promotions using installation packages for installing the host applications, comprising: installing a trial version of a payload application on a customer computer, wherein the trial version of the payload application is bundled with a host application in an installation package provided by a host application publisher; and reporting a bounty triggering event for the trial version of the payload application to an exchange server so that an agreed upon bounty corresponding to the bounty triggering event is to be paid by a payload application publisher to the host application publisher.

Additional objects, features and advantages of the various aspects of the present invention will become apparent from the following description of its preferred embodiment, which description should be taken in conjunction with the accompanying drawings.

### BRIEF DESCRIPTION OF THE DRAWINGS

FIG. 1 illustrates generation of an installation package by packaging a set of Payload Application modules with a set of Host Application modules using a conventional packaging program.

FIG. 2 illustrates a snapshot of a computer screen displayed to allow a user to install a Payload Application that has been bundled with a Host Application in a conventional installation package.

FIG. 3 illustrates a block diagram including computers and software that interact to perform a Marketing Service which provides a market for the distribution of promotional material using installation packages, utilizing aspects of the present invention.

FIG. 4 illustrates a page displayed on a computer screen by a Packaging Program utilizing aspects of the present invention to allow a user to initiate registration of an Application to serve as a Payload or Host Application.

FIG. 5 illustrates a page displayed on a computer screen by a Packaging Program utilizing aspects of the present invention to allow a user to initiate registration of as an Advertiser or Deliverer of promotional Media Objects.

FIG. 6 illustrates a page displayed on a computer screen by a Packaging Program utilizing aspects of the present invention to allow a user to provide Bounty information including Bounty amount(s), distribution constraints, and other terms of an ad hoc partnership for the distribution of Material that is to be distributed using installation packages of other Publishers.

FIGS. 7-8 illustrate corresponding flow diagrams of methods respectively performed by a Packaging Program and an Exchange Interface Program as they interact during user registration as a Payload Application Publisher or Advertiser, utilizing aspects of the present invention.

FIG. 9 illustrates a page displayed on a computer screen by a Packaging Program utilizing aspects of the present invention to allow Publishers to utilize Bounty information to select the Payload Application(s) to distribute using their installation packages from among specification matching sets of participating Payload Applications available in the electronic marketplace.

FIG. 10 illustrates a page displayed on a computer screen by a Packaging Program utilizing aspects of the present invention to allow publishers to utilize Bounty information to select the promotional Media Object(s) to distribute using its installation packages from among a specification matching set of participating Media Objects available in the electronic marketplace.

FIGS. 11-12 illustrate corresponding flow diagrams of methods respectively performed by a Packaging Program and an Exchange Interface Program as they interact to provide offered Bounty information to a Host Application Publisher, utilizing aspects of the present invention.

FIGS. 13-16 illustrate related portions of a method performed by an Installer as it communicates and cooperates with an Exchange Interface Program to determine which Applications are to be offered for installation and/or which promotional Media Objects are to be played, utilizing aspects of the present invention.

FIG. 17 illustrates a method performed by an Exchange Interface Program as it communicates and cooperates with an Installer on a customer computer to determine which Applications are to be offered for installation and/or which promotional Media Objects are to be played, utilizing aspects of the present invention.

FIG. 18 illustrates a method performed by a Bounty Accounting Program in cooperation with an Installer and an Exchange Interface Program to update Participant accounts resulting from a Promotion being distributed using an installation package, utilizing aspects of the present invention.

FIG. 19 illustrates a block diagram of the Marketing Service including participants interacting with an Exchange Server through Publisher and Advertiser Computers, utilizing aspects of the present invention.

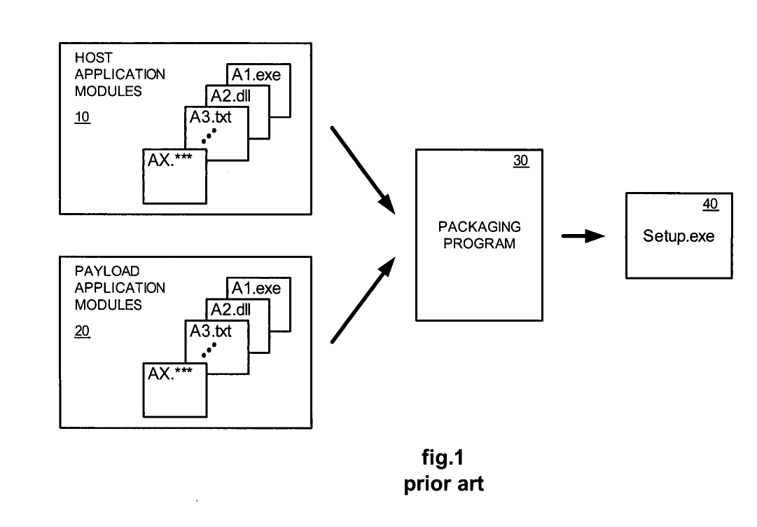

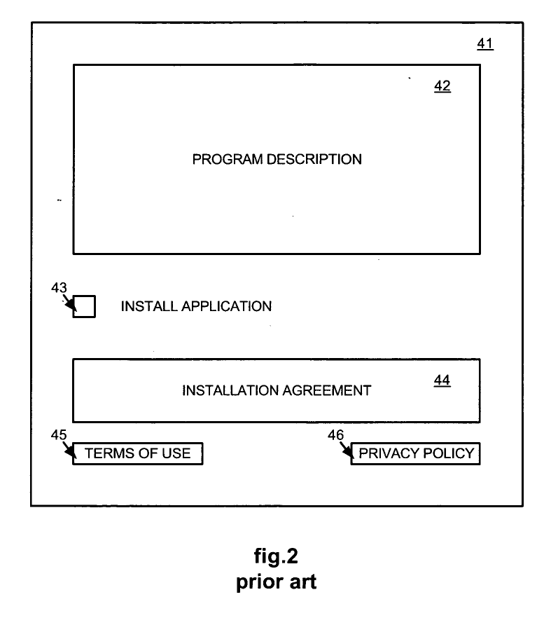

### DETAILED DESCRIPTION OF THE PREFERRED EMBODIMENT

As used herein, “Application” means an executable computer program; “Media Object” means an object or file including data such as text, sound, pictures, and video; “Material” means anything that can be stored electronically such as an Application or Media Object; “Promotion” means Material that promotes a product or service; “Publisher” means a distributor of an Application; “Advertiser” means an entity or person promoting a product or service using a Media Object; “Promoter” means an entity or person sponsoring a Promotion; “Marketing Service” means a service providing a market for the distribution of promotional Material or Promotions using Software Installation Systems such as described herein; “Service Provider” means an entity providing the Marketing Service; “Participant” means an entity or person registered to use the Marketing Service; “Software Installation System” means a system for installing software on a computer including a packaging program, installation package, and installer; and “Bounty” means a fee to be paid by a Promoter to a Host Publisher for distributing the Promoter's Promotion(s) using installation packages for installing a Host Application of the Host Publisher. Other terms may also be defined herein throughout the description of the preferred embodiment.

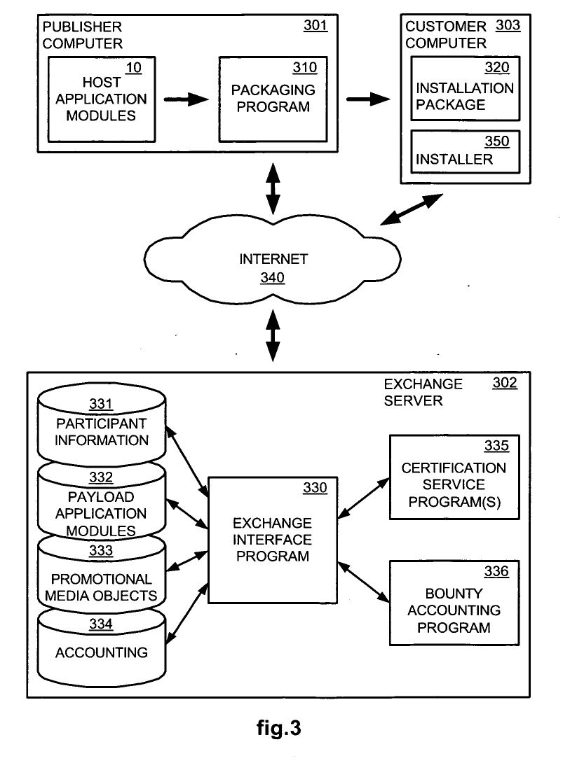

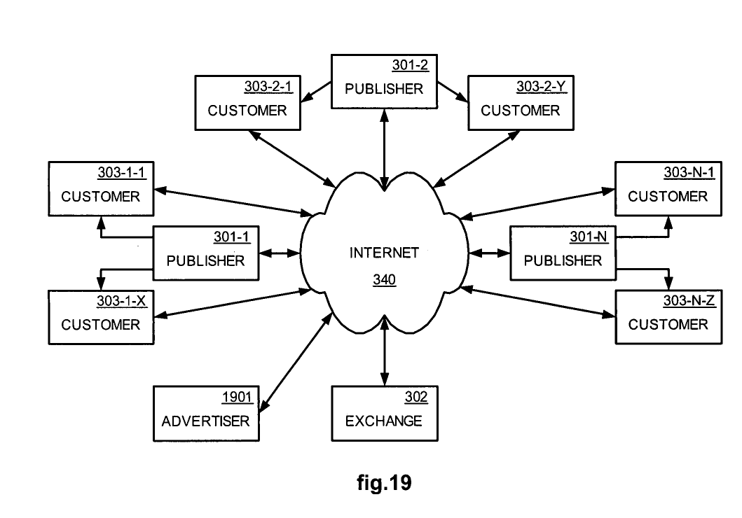

FIG. 3 illustrates, as an example, a block diagram including computers and software that interact to perform the Marketing Service by providing a market for the distribution of promotional Material using software installers. Key computing entities are a Publisher Computer 301, Exchange Server 302, and Customer Computer 303. Although only one each of the publishing and customer computers is shown and described herein, the Exchange Server 302 interacts with many such publishing computers and many more such consumer computers in the manner described in reference to the Publishing Computer 301 and the Consumer Computer 303, and as further described in reference to FIG. 19, in performing its tasks for the Marketing Service.

A Packaging Program 310 resides on the Publishing Computer 301, which is operated by a Publisher to generate installation packages which are distributed to its customers to install Application(s) and/or deploy Media Object(s) on their computers using compatible software installers. For convenience, this Application is referred to herein as the “Host Application”, and the generated installation packages include host application modules 10 as conventionally required for proper installation of the Host Application on consumer computers. As an example of one such installation package, the Customer Computer 303 is shown as having Installation Package 320 residing on it, which has been generated by the Packaging Program 310 and provided to the Customer Computer 303 by a conventional method such as downloading it from the Publishing Computer 301 or loading it from a physical medium, such as a Compact Disc (“CD”), generated by the Publishing Computer 301.

An Exchange Interface Program 330 resides on the Exchange Server 302, which is operated by a Service Provider to provide the Marketing Service. In addition to the Exchange Interface Program 330, a number of databases and various support software modules also reside on the Exchange Server 302, or are otherwise available to it through a resource sharing network. The databases may be separate as shown and conventionally linked, or they may be merged into one or more larger databases that are linked together.

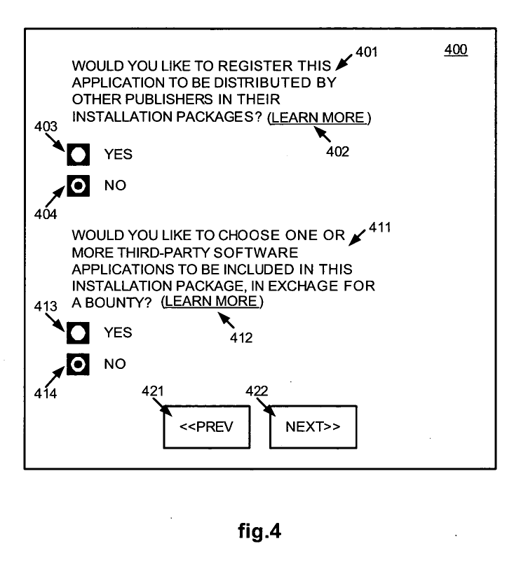

A Participant Information database 331 includes information on Participants registered to use the Marketing Service. A Participant is an entity or person who is any one or more of the following: Publishers of Host Applications (“Host Publishers”), who have registered with the Marketing Service to allow use of their installation packages for installing their Applications (“Host Applications”) for distributing Promotions of other Participants for an agreed upon Bounty; Publishers of Payload Applications (“Payload Publishers”), who have registered with the Marketing Service to have trial versions of their installable Applications (“Payload Applications”) distributed using the installation packages of Host Publishers; and Advertisers of promotional Media Objects, who have registered with the Marketing Service to have their Media Objects distributed using installation packages for installing Host Applications of Host Publishers. Contents of the Participant Information database 331 will be described for each type of Participant in the following description provided in reference to FIGS. 4-12.

A Payload Application Modules database 332 contains Payload Application modules which are linked to their respective Publisher Participants and used for generating installable Payload Applications. Similarly, a Promotional Media Objects database 333 contains Media Objects linked to their respective Advertiser Participants. In addition to linking to their respective Publisher and Advertiser Participants, entries in the Payload Application Modules database 332 and the Promotional Media Objects database 333 are also linked to Host Publishers in the Participant Information database 331, who have agreed to distribute their respective Payload Applications and/or Promotional Media Objects. In cases where a Participant may participate in multiple capacities, such as a Host Publisher for distributing other Participants' Payload Applications and Media Objects, a Payload Publisher for having trial versions of its Application distributed using other Participants' installation packages, and an Advertiser for promoting its products and/or services in promotional Media Objects distributed using other Participants' installation packages, corresponding links may be established from both the Payload Application Modules database 332 and the Promotional Media Objects database 333 to that Participant's entry in the Participant Information database 331.

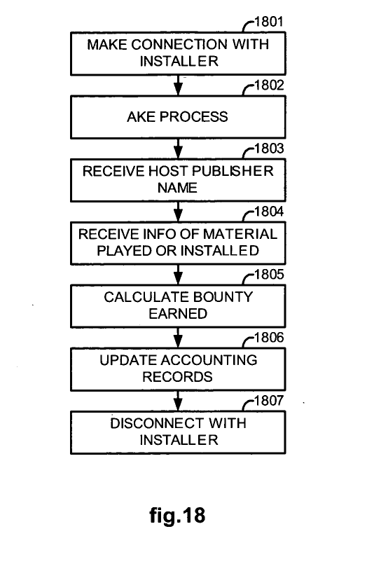

An Accounting database 334 contains accounting information as updated by a Bounty Accounting Program 336 for each of the Participants registered to use the Marketing Service according to the Participant Information database 331. For Publishers of Payload Applications and Advertisers, their accounts indicate monies owed to Publishers of Host Applications according to agreed upon Bounties. Conversely, for Publishers of Host Applications, their accounts indicate monies owed from the Publishers of Payload Applications and Advertisers whose Payload Applications and promotional Media Objects they are causing to be distributed, installed or purchased, as the case may be, using installation packages generated for distributing their Host Applications to their customers. Additional details for such Bounty accounting will be described in the following description in reference to FIG. 18.

One or more Certification Service Programs 335 may also reside on or be available to the Exchange Server 302. As an example of one type of certification service, the Service Provider may install each Payload Application to confirm that it is installable and also to check to see if it contains any viruses or spyware. If the Payload Application is installable and clean, then it may be certified as being so by the Service Provider so that Publishers of Host Applications are assured that bundling of the Payload Application with their Host Application will not create ill-will with their customers. Conversely, the Service Provider may also install each Host Application to confirm that it is installable and also to check to see if it contains any viruses or spyware. If the Host Application is installable and clean, then it may be certified as being so by the Service Provider so that Publishers of Payload Applications are assured that bundling of their Payload Application with the Host Application will not create ill-will with their prospective customers.

As an example of another type of certification service, the Service Provider may also play promotional Media Objects to determine whether they contain, for example, objectionable levels of violence, sex or extreme political or religious viewpoints, and certify whether they do or not in each of a number of categories conventionally used in rating entertainment media.

As an example of yet another type of certification service, the Service Provider may perform or engage others to perform credit checks on the financial condition of participating Publishers and Advertisers, so that concerns regarding the ability Payload Application Publishers and Advertisers to pay Bounties can be minimized and in the case of Host Application Publishers, their viability as continuing concerns to distribute Payload Applications and promotional Media Objects to prospective customers are reasonably assured.

Participants may register for the Marketing Service by simply going to and doing so at a website hosted by the Service Provider, or the Marketing Service may simply publish external machine interfaces (e.g., APIs) that enable third-party applications and services to transact with the Marketing Service. Another method for registering is to use packaging programs which have been configured to support the Marketing Service. In this regard, the Packaging Program 310 may either be a custom program configured to support the Marketing Service and generate installation packages of particular formats, or it may be a program wrapped around or otherwise added to a standard packaging program. Although only the packaging program approach for Participant registration is described herein, implementations to accommodate other modes of registration are straightforward extensions of the described computer screen displays and user interactions with those displays.

In addition to the Installation Package 320 residing on the Customer Computer 303, an Installer 350 also resides on the Customer Computer 303. The Installer 350 is a software installer that may be separately provided and installed on the Customer Computer 303, or it may be provided along with the Installation Package 320.

FIG. 4 illustrates, as an example, a page 400 being displayed on a computer screen by the Packaging Program 310 during generation of an installation program for an Application including Host Application modules 10, which allows a user of the Publisher Computer 301 to register the Application with the Marketing Service. Selections indicated by the user clicking appropriate buttons on this page 400 (using, for example, a mouse controlled cursor) are subsequently sent over the Internet 340, along with other information as described herein, to the Exchange Interface Program 330 on the Exchange Server 302, whose Internet address has been programmed into or otherwise made available to the Packaging Program 310. Although this figure describes registration where installable modules of a Payload Application are to be bundled in with installable modules of a Host Application, a similar page may also be displayed where the Payload Application is only referenced in the installation package as described elsewhere in the description.

In a first area 401 of the page 400, the user is asked whether he or she would like to register the Application (i.e., as a Payload Application) to be distributed by other Publishers in installation packages for their Applications. If the user would like to learn more about how such distribution works, he or she can click on a link 402. Otherwise, to respond to the question, the user may click either a YES button 403 or a NO button 404. In this example, the NO button 404 is pre-clicked, so that the user is required to affirmatively click the YES button 403 in order to indicate that choice.

Similarly, in a second area 411 of the page 400, the user is asked whether he or she would like to choose one or more third-party software applications to be included in the installation package being generated for his or her Application (i.e., this time acting as a Host Application) in exchange for a Bounty. If the user would like to learn more about Bounties, how such fee arrangements may be structured, and additional details on any accounting services that may be offered as part of the Marketing Service, he or she can click on a link 412. Otherwise, to respond to the question, the user may click either a YES button 413 or a NO button 414. Configured for “opt-in” participation, the NO button 414 is pre-clicked in this case, so that the user is required to affirmatively click the YES button 413 in order to indicate that choice. However, the service may also be configured for “opt-out” participation, in which case the YES button is pre-clicked, and the user is required to affirmatively click the NO button in order to indicate that choice.

For convenience, once the user has registered the Application as being a Payload Application or Host Application, this page 400 may not appear on the computer screen unless specifically requested by the user in order to subsequently register (if not previously done so), de-register, or change the terms of registration of the Application with the Marketing Service.

In addition to registering his or her Application to serve as a Host Application or Payload Application for a specified Bounty, the user may also register to be an Advertiser or a Deliverer of promotional Media Objects during the generation of an installment package for his or her Application by the Packaging Program 310.

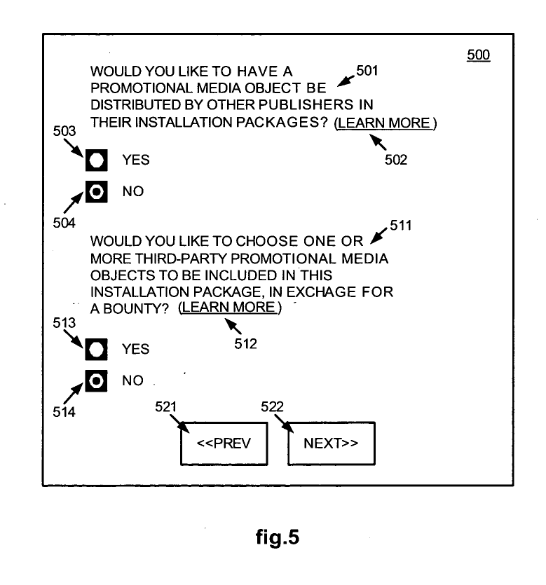

FIG. 5 illustrates, as an example, a page 500 being displayed on a computer screen by the Packaging Program 310 during generation of an installation program for an Application including Host Application modules 10, which allows a user of the Publisher Computer 301 to register with the Marketing Service as an Advertiser and/or Deliverer of promotional Media Objects. As with page 400, selections indicated by the user clicking appropriate buttons on this page 500 are subsequently sent over the Internet 340, along with other information as described herein, to the Exchange Interface Program 330.

In a first area 501 of the page 500, the user is asked whether he or she would like to have a promotional Media Object distributed by other Publishers in their installation packages (i.e., thus being an Advertiser of the promotional Media Object). If the user would like to learn more about how such advertising works, he or she can click on a link 502. Otherwise, to respond to the question, the user may click either a YES button 503 or a NO button 504. In this example, the NO button 504 is pre-clicked, so that the user is required to affirmatively click the YES button 503 in order to indicate that choice.

Similarly, in a second area 511 of the page 500, the user is asked whether he or she would like to choose one or more third-party promotional Media Objects to be included in the installation package being generated for his or her Application (i.e., this time acting as a “Deliverer” of promotional Media Objects) in exchange for Bounty. If the user would like to learn more about Bounties, how such fee arrangements may be structured, and additional details on any accounting services that may be offered as part of the Marketing Service, he or she can click on a link 512. Otherwise, to respond to the question, the user may click either a YES button 513 or a NO button 514. As described previously, the NO button 514 is pre-clicked in this case, so that the user is required to affirmatively click the YES button 513 in order to indicate that choice.

For convenience, once the user has registered as being either or both an Advertiser or Deliverer of promotional Media Objects, this page 500 may not appear on the computer screen unless specifically requested by the user in order to subsequently register (if not previously done so), de-register, or change the terms of registration of his or her status with the Marketing Service.

Now continuing with the registration process, if the user has clicked any YES button on pages 400 or 500, he or she will be required to provide additional information regarding maximum Bounties which he or she is willing to pay to participate as a Payload Application Publisher or Advertiser, or minimum Bounties which he or she is willing to accept to participate as a Host Application Publisher to Payload Applications or promotional Media Objects of other Parties, as well as other information which serve to match the user with other Participants for any of those arrangements.

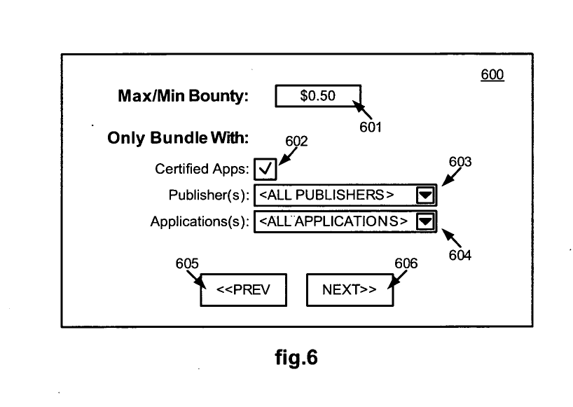

FIG. 6 illustrates, as a simplified example, a page 600 displayed on a computer screen by the Packaging Program 310 during generation of an installation program for an Application including Host Application modules 10, to allow a user to provide Bounty and other information during his or her (i.e., the Publisher's) registration as a Participant of the Marketing Service after each time the user has clicked a YES button on page 400 or 500.

A maximum or minimum Bounty may be specified by the user typing in the amount in a first area 601 on the page 600. The amount entered is understood to mean a maximum Bounty that the user is willing to pay when the user is registering as a Payload Application Publisher by clicking the YES button 403 on page 400 or registering as an Advertiser by clicking the YES button 503 on page 500. On the other hand, it is understood to mean a minimum Bounty that the user is willing to accept when the user is registering as a Host Application Publisher by clicking the YES button 413 on page 400 or the YES button 513 on page 500. Note that each time the user registers by clicking one of the YES buttons on pages 400 and 500, Bounty information for that registration must be provided by the user filling in page 600.

Although only one Bounty entry 601 is shown, several entries may be provided to accommodate a more complex fee structure. For example, in this single Bounty example, the Bounty may be earned each time a Payload Application is offered for installation on a customer computer during the installation of a Host Application, or each time a promotional Media Object is played or otherwise displayed on the computer screen of the customer computer during the installation of the Host Application.

In a multiple Bounty example, however, a first Bounty amount may be earned when a trial version of a Payload Application is offered for installation, a second Bounty amount may be earned when the trial version of the Payload Application is installed, a third Bounty amount may be earned after the first time the trial version of the Payload Application is used by a prospective customer, a fourth Bounty amount may be earned after a customer converts the trial version of the Payload Application to a full version, and a fifth Bounty amount may be earned after a customer renews an annual maintenance agreement. The trial version of the Payload Application may be limited in time or limited in feature, as is commonly practiced in software licensing. Other ways a Bounty may be specified and earned include those involving ongoing bases such as, for Payload Applications, a specified fraction of recurring subscription fees, and for promotional Media Objects, reduced and/or scaled fee amounts for each additional advertising impression resulting from a replaying of the Media Object. Note that for viral distribution of an installation package, from an initially authorized customer computer to other computers, the installer on each of the computers will report separately to the Exchange Server 302, so that multiple Bounties may be earned from the same installation package in such case.

Each of the various Bounty amounts in this multiple Bounty example may be specified in its own area for entry in a modified version of page 600. A key advantage of the present invention is the capability to accommodate (by both providing and accounting for) such multiple Bounty arrangements, using a specially adapted Installer and/or wrap-around programs, which communicate Bounty triggering activity to an Exchange Interface Program residing on an Exchange Server controlled by the Service Provider. The wrap-around programs may be provided in the installation packages and installed by the Installer so as to “wrap-around” a standard installer and/or the trial and/or full version of the Payload Application so that the wrapped around programs (i.e., the installer or Payload Application) are executed through the wrap-around program in addition to the Bounty reporting activities.

Additional Bounty related information may also be provided by the user interacting with other parts of page 600. For example, by checking (i.e., clicking on) a box 602, the user may specify whether or not a Payload Application must be certified when the user is registering as a Host Application Publisher, or whether or not the Host Application must be certified when the user is registering as either a Payload Application Publisher or Advertiser. The certification in this case may be for one of those performed by the Certification Service Programs 335 or one performed by an outside agency. Where more than one thing is certifiable, a check box for each of those things is preferably provided.

For another example of Bounty related information that may be provided through user interaction with page 600, the user may limit which Publishers that he or she is willing to do business with through choices provided, for example, using a pull-down menu 603, or the user may elect not to limit which Publishers that he or she is willing to do business with by accepting the default that all Publishers are acceptable, as shown in FIG. 6.

The pull-down menu 603 may limit Publisher choices in this case by providing a list of all Publishers from which the user may select, and the user may then select those Publishers which he or she is willing to do business with by clicking on their name while holding the Ctrl key down. Alternatively, the pull-down menu 603 may limit Publisher choices by providing a number of categories within which each of the registered Publishers has been sorted into, and the user may then select one of those categories to limit the number of Publishers to do business with.

As an example of the first case, the list of Publishers shown by the pull-down menu 603 may include all Host Application Publishers willing to distribute Payload Applications when the user is registering as a Payload Application Publisher. Alternatively, it may include all Host Application Publishers willing to distribute promotional Media Objects when the user is registering as an Advertiser. As yet other alternatives, the list of Publishers may include all Payload Application Publishers when the user is registering as a Host Application Publisher willing to distribute third party Payload Applications, or it may include all Advertisers when the user is registering as a Host Application Publisher willing to distribute third party promotional Media Objects.

For another example of Bounty related information that may be provided through user interaction with page 600, the user may limit which Host or Payload Applications that he or she is willing to be bundled with through category choices provided, for example, using a pull-down menu 604, or the user may elect not to limit which Applications that he or she is willing to be bundled with by accepting the default that all Applications are acceptable, as shown in FIG. 6.

Now referring back to the pull-down menu 603, to reduce the number of Publishers listed by the pull-down menu 603, the list may be further restricted to include only those Publishers who would be willing to do business with the user, based upon matching corresponding input of the parties during their respective registration processes. For example, if the Application of the user currently registering is in a category does not match one of those that the candidate Publisher has selected, then that Publisher is not included in list of Publishers that the registrant user might see in the pull-down menu 603.

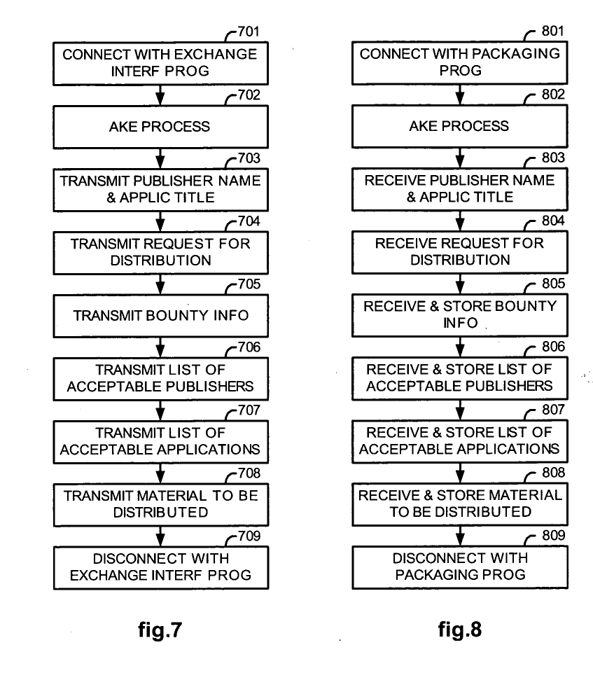

FIGS. 7-8 illustrate, as examples, corresponding flow diagrams of methods respectively performed by the Packaging Program 310 and the Exchange Interface Program 330 as they interact during user registration as either a Payload Application Publisher or Advertiser. In 701 and 801, the Packaging Program 310 residing on the Publisher Computer 301 and the Exchange Interface Program 330 residing on the Exchange Server 302 make connection with each other. In the present example, this is done by the Packaging Program 310 initiating the connection in a conventional manner using an IP address of the Exchange Server 302, and a directory listing of the Exchange Interface Program 330 on the Exchange Server 302 which has programmed into the Packaging Program 301 or otherwise made available to it. In 702 and 802, the Packaging Program 310 and the Exchange Interface Program 330 then perform a conventional Authentication and Key Exchange (“AKE”) procedure to authenticate each other and establish a secure connection for communications.

In 703 and 803, the Packaging Program 310 transmits and the Exchange Interface Program 330 receives the registering user's Publisher name (or Advertiser name, as the case may be) and Application title (or Media Object title), which the user has provided to the Packaging Program 310 at some time during either the installation package generation or registration process if the user is registering as a Payload Application Publisher, or during the registration process if the user is registering as an Advertiser. If this is the first instance for this Publisher and/or Application, a corresponding entry is generated in the Participant Information database 331 by the Exchange Interface Program 330.

In 704 and 804, the Packaging Program 310 transmits and the Exchange Interface Program 330 receives the registering user's request for distribution of his or her Payload Application as indicated by the user clicking the YES button 403 on page 400, or promotional Media Object as indicated by the user clicking on the YES button 503 on page 500 during the user's registration process, and the Publisher's (or Advertiser's) record in the Participant Information database 331 is updated accordingly by the Exchange Interface Program 330.

In 705-707 and 805-807, the Packaging Program 310 transmits and the Exchange Interface Program 330 receives the registering user's Bounty information, list of acceptable Publishers, list of acceptable Applications, and other attributes or partnership constraints which have been provided to the Packaging Program 310 by the user during the registration process as described in reference to FIG. 6, and the Publisher's (or Advertiser's) record in the Participant Information database 331 is updated accordingly by the Exchange Interface Program 330.

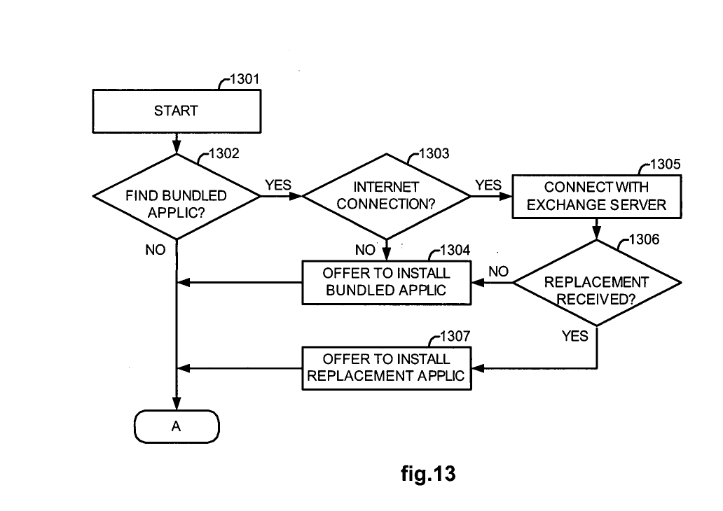

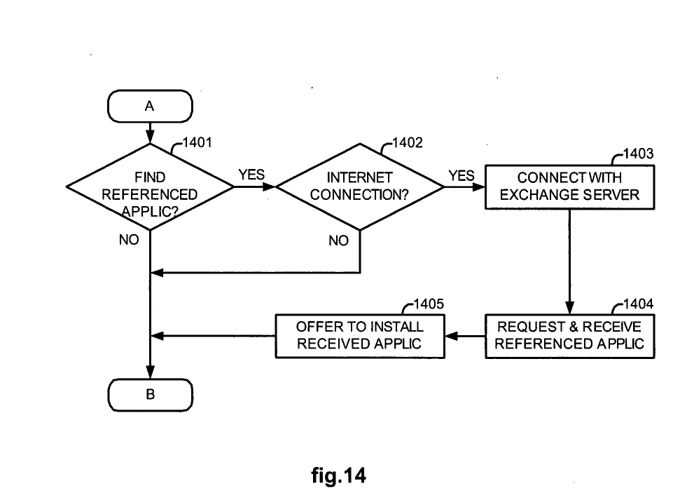

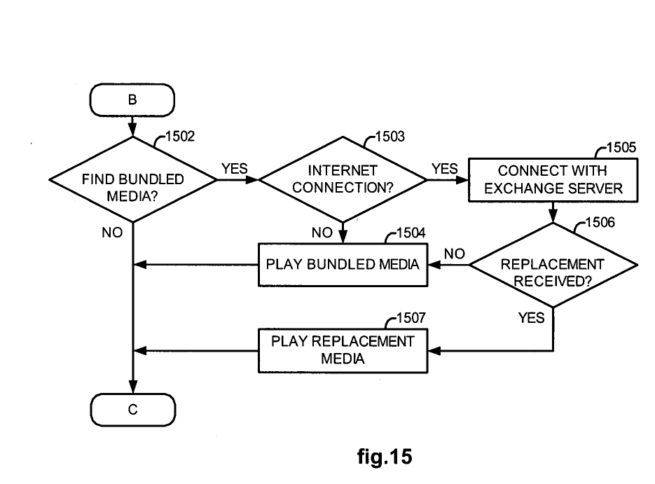

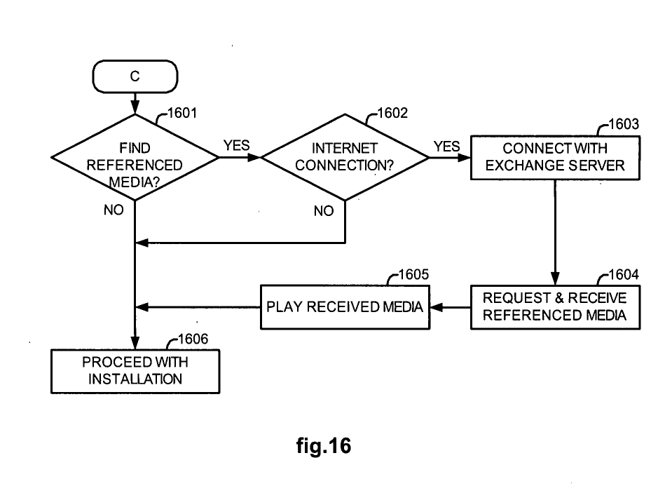

In 708 and 808, the Packaging Program 310 transmits and the Exchange Interface Program 330 receives the Material to be distributed. If the user is registering as a Payload Application Publisher, then the Material in this case is the user's Payload Application modules, which may be bundled with Host Application modules in its installation package or referenced in the installation package for subsequent download from the Exchange Server 302 upon customer election to install (both subject to replacement or update as described in reference to FIGS. 13-14). On the other hand, if the user is registering as an Advertiser, then the Material in this case is the user's promotional Media Object, which may be bundled with the Host Application modules in its installation package or referenced in the installation package for subsequent download from the Exchange Server 302 prior to its being played or displayed (subject to replacement or update as described in reference to FIGS. 15-16).

Finally, in 709 and 809, the Packaging Program 310 and Exchange Interface Program 330 disconnect from each other. Although the method described in reference to FIGS. 7 and 8 indicate that connection is maintained throughout the process, it is to be appreciated that the Packaging Program 310 and Exchange Interface Program 330 may repeatedly connect and disconnect throughout the process, as is common with packet based communications conducted over the Internet 340.

If the user has registered as a Host Application Publisher, then he or she may then select the Publishers and Payload Applications (or Advertisers and promotional Media Objects, as the case may be) that he or she is willing to distribute or reference in his or her Host Application's installation packages.

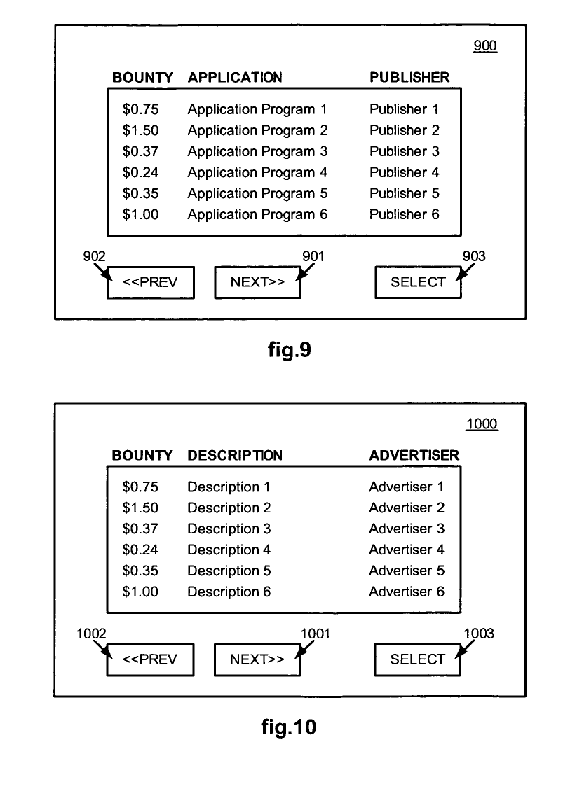

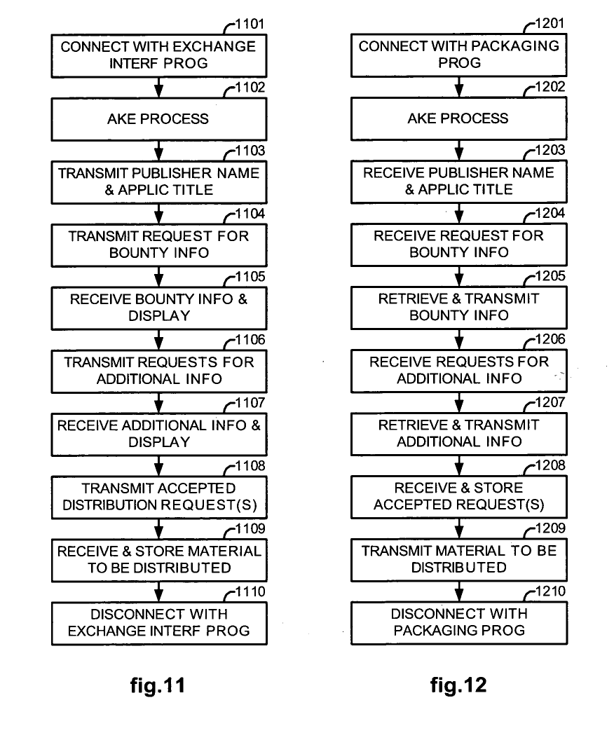

FIG. 9 illustrates, as an example, a page 900 displayed on a computer screen by the Packaging Program 310 to display Bounties being offered by participating Publishers to be paid to Host Application Publishers for distributing their Payload Applications. In order to obtain the information displayed on this page 900, the Packaging Program 310 on the Publisher Computer 301 communicates with the Exchange Interface Program 330 on the Exchange Server 302 in a manner generally described in reference to FIGS. 11-12.

Each row specifies a Publisher name in a PUBLISHER column, an Application title in an APPLICATION column, and a Bounty amount in a BOUNTY column. Ordering may be alphabetically by Publisher name or by Bounty amount with the highest Bounties first on the list. For additional information on a Publisher, such as its address, corporate profile, products, link to its website, credit rating, latest available financials, or comments provided from other Host Application Publishers distributing one of the Publisher's Applications, the user may double click on the Publisher name. Likewise, for additional information on a prospective Payload Application such as a product description, the user may double click on the Application title. A NEXT button 901 may be clicked to go to a next page to see additional entries that did not fit on page 900, and a PREV button 902 may be clicked to go back to a previous page.

FIG. 10 illustrates, as an example, a page 1000 displayed on a computer screen by the Packaging Program 310 to display Bounties being offered by participating Advertisers to be paid to Host Application Publishers for distributing their promotional Media Objects. In order to obtain the information displayed on this page 1000, the Packaging Program 310 on the Publisher Computer 301 communicates with the Exchange Interface Program 330 on the Exchange Server 302 in a manner generally described in reference to FIGS. 11-12.

Each row specifies an Advertiser name in an ADVERTISER column, a brief Media Object description or title in a DESCRIPTION column, and a Bounty amount in a BOUNTY column. Ordering may be alphabetically by Advertiser name or by Bounty amount with the highest Bounties first on the list. For additional information on an Advertiser, such as its address, corporate profile, products, link to its website, credit rating, latest available financials, or comments provided from other Host Application Publishers distributing one of the Advertiser's promotional Media Objects, the user may double click on the Advertiser name. Likewise, for additional information on a product or service being promoted in the Media Object such as a product or service description, the user may double click on the Media Object description. A NEXT button 1001 may be clicked to go to a next page to see additional entries that did not fit on page 1000, and a PREV button 1002 may be clicked to go back to a previous page.

With regards to both FIGS. 9 and 10, when more complex Bounty arrangements are offered, additional information is to be provided accordingly. Preferably, this may be accomplished by adding additional columns to show any additional Bounties paid for different Bounty triggering events, such as the Bounty paid upon offering to install a trial version of the Payload Application, the Bounty paid upon actually installing the trial version of the Payload Application, the Bounty paid upon first use of the installed trial version of the Payload Application, the Bounty paid upon upgrading to a full version of the Payload Application, and the Bounty paid upon renewing an annual maintenance subscription for the full version of the Payload Application. Preferably, the information may be reorganized at any time by the user clicking on the respective BOUNTY column heading for any of the types of Bounty, so that the highest paid Bounties for that type are on top of the displayed list.

FIGS. 11-12 illustrate, as examples, corresponding flow diagrams of methods respectively performed by the Packaging Program 310 and Exchange Interface Program 330 as they interact to provide offered Bounty information to a Host Application Publisher, as described in reference to FIGS. 9 and 10. In 1101 and 1201, the Packaging Program 310 residing on the Publisher Computer 301 and the Exchange Interface Program 330 residing on the Exchange Server 302 make connection with each other. In the present example, this is done by the Packaging Program 310 initiating the connection in a conventional manner using an IP address of the Exchange Server 302, and a directory listing of the Exchange Interface Program 330 on the Exchange Server 302 which has been programmed into the Packaging Program 301 or otherwise made available to it. In 1102 and 1202, the Packaging Program 310 and the Exchange Interface Program 330 then perform a conventional Authentication and Key Exchange (“AKE”) procedure to authenticate each other and establish a secure connection for communications.

In 1103 and 1203, the Packaging Program 310 transmits and the Exchange Interface Program 330 receives the Host Application Publisher name and Host Application title, which the user has provided to the Packaging Program 310 at some time during either the installation package generation or registration process.

In 1104 and 1204, the Packaging Program 310 transmits and the Exchange Interface Program 330 receives the user's request for Bounty information. In 1205 and 1105, the Exchange Interface Program 330 retrieves and/or determines the appropriate Bounty information for the Host Application Publisher and transmits the information to the Packaging Program 310, and the Packaging Program 310 displays the received Bounty information on the computer screen of the Publishing Computer 301 as shown and/or described, for example, in reference to FIGS. 9 and 10.

If the Packaging Program 310 receives any requests from the user for additional information regarding Publishers or Payload Applications as described in reference to FIG. 9, or Advertisers or their promotional Media Objects as described in reference to FIG. 10, then in 1106 and 1206, the Packaging Program 310 transmits and the Exchange Interface Program 330 receives those requests. In 1207 and 1107, the Exchange Interface Program 330 then retrieves the additional information and transmits it to the Packaging Program 310, and the Packaging Program 310 displays the information on the computer screen of the Publishing Computer 301 as described, for example, in reference to FIGS. 9 and 10.

The user may select a Payload Application Publisher or Advertiser to do business with by, for example, double clicking on its Bonus amount as shown in FIGS. 9 and 10, or alternatively, highlighting the Publisher by single clicking on the Publisher name or its Payload Application name as shown in FIG. 9 and clicking on the SELECT button 903, or highlighting the Advertiser by single clicking on the Advertiser name or Media Object description as shown in FIG. 10 and clicking on the SELECT button 1003. For the selection of multiple Payload Application Publishers or Advertisers, the Ctrl key may be held down in a conventional manner to highlight multiple Publishers or Advertisers before clicking on the appropriate SELECT button.

If the user has selected either one or more Payload Application Publishers or Advertisers to do business with, then in 1108 and 1208, the Packaging Program 310 transmits and the Exchange Interface Program 330 receives and stores that information. If the Payload Applications or promotional Media Objects are to be bundled with the Host Application in its installation package, then in 1209 and 1109, the Exchange Interface Program 330 retrieves and transmits that Material, and the Packaging Program 310 receives and stores it in its permanent memory. Thereafter, when the Packaging Program 310 is to generate an installation package for the Host Application, it copies the Payload Application modules and/or promotional Media Objects stored in its memory to the installation package being generated.

Finally, in 1110 and 1210, the Packaging Program 310 and Exchange Interface Program 330 disconnect from each other. Although the method described in reference to FIGS. 11 and 12 indicate that connection is maintained throughout the process, it is to be appreciated that the Packaging Program 310 and Exchange Interface Program 330 may repeatedly connect and disconnect throughout the process, as may occur with packet based communications conducted over the Internet 340.

Although the Marketing Service has been described as primarily bundling Payload Application modules with Host Application modules in installation packages, and/or bundling promotional Media Objects with Host Application modules in installation packages, it is advantageous and fully contemplated herein to provide a Marketing Service wherein rather than bundling these items with the Host Application modules in the installation package, they may be referenced in script or otherwise within the installation package instead, and subsequently downloaded by the installation package onto a customer computer such as by Installation Package 320 onto Customer Computer 303 from the Exchange Server 302 by communicating with the Exchange Interface Program 330. Hybrid forms of bundling and referencing are also contemplated, so that if an Internet connection cannot be made, the bundled Material is used as a default.

FIGS. 13-16 illustrate, as an example, related portions of a method performed by the Installer 350 which executes script stored in the Installation Package 320 or instructions coded into the Installer 350 to instruct it to communicate with the Exchange Interface Program 330 to determine which trial versions of Payload Applications are to be offered for installation and/or which promotional Media Objects are to be played and/or displayed on the Customer Computer 303 during the installation process for the Host Application. The method accommodates bundled Material, referenced Material, and a hybrid version providing certain characteristics of both bundled Material and referenced Material.

Starting with FIG. 13, in 1301, the Installer 350 starts executing script of the Installation Package 320, and in 1302, it looks to see if any Payload Application modules have been bundled in with the Host Application modules in the Installation Package 320. If no Payload Application modules are found, then the method continues on to a next stage, as indicated by the letter A. On the other hand, if Payload Application modules are found, then in 1303, the Installer 350 checks to see if an Internet connection exists for the Customer Computer 303. If no Internet connection exists, then in 1304, the Installer 350 offers the user of the Customer Computer 303 an opportunity to install, as a default in this case, a trial version of the Payload Application. It then continues on the next stage, as indicated by the letter A.

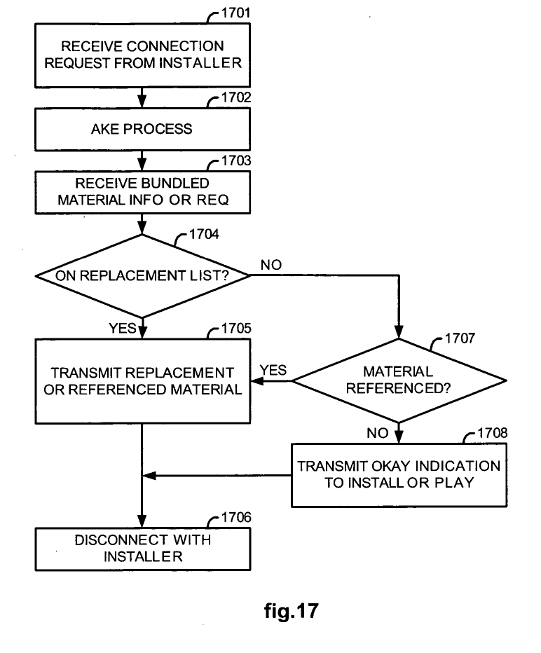

On the other hand, if an Internet connection is found in 1303, then in 1305, the Installer 350 initiates a connection with the Exchange Interface Program 330 on the Exchange Server 302 so that the Exchange Interface Program 330 may perform the method described in reference to FIG. 17, with the cooperation of the Installer 350, to determine whether the bundled trial version of the Payload Application needs to be replaced. If the bundled trial version of the Payload Application does not need replacement, then an indication to that effect is received from the Exchange Interface Program 330, and in 1306, the received indication causes the Installer 350 to proceed to 1304, so that the Installer 350 offers the user of the Customer Computer 303 an opportunity to install the bundled trial version of the Payload Application. It then continues on the next stage, as indicated by the letter A.

If, however, the bundled trial version of the Payload Application does need replacement, then a replacement trial version of a Payload Application is received from the Exchange Interface Program 330, and in 1306, the received replacement trial version of a Payload Application causes the Installer 350 to proceed to 1307, so that the Installer offers the user of the Customer Computer 303 an opportunity to install the trial version of the replacement Payload Application. It then continues on the next stage, as indicated by the letter A.

Referring now to FIG. 14, in 1401, the Installer 350 then looks to see if a Payload Application is referenced somewhere in the Installation Package 320. If no Payload Application reference is found, then the method continues on to a next stage, as indicated by the letter B. Alternatively, if a Payload Application reference is found, then in 1402, the Installer 350 checks to see if an Internet connection exists for the Customer Computer 303. If no Internet connection exists, then the method continues on the next stage, as indicated by the letter B.

On the other hand, if an Internet connection is found in 1402, then in 1403, the Installer 350 initiates a connection with the Exchange Interface Program 330 on the Exchange Server 302 so that the Exchange Interface Program 330 may perform the method described in reference to FIG. 17, with the cooperation of the Installer 350, to determine whether the referenced Payload Application is to be downloaded from the Exchange Interface Program 330, or a replacement for that Payload Application is required. In any event, in 1404, a trial version of the correct Payload Application is received from the Exchange Interface Program 330, and in 1405, the Installer 350 offers the user of the Customer Computer 303 an opportunity to install the received trial version of the Payload Application. It then continues on the next stage, as indicated by the letter B.

Referring now to FIG. 15, in 1501, the Installer 350 then looks to see if a promotional Media Object has been bundled in with the Host Application modules in the Installation Package 320. If no promotional Media Object is found, then the method continues on to a next stage, as indicated by the letter C. On the other hand, if a promotional Media Object is found, then in 1503, the Installer 350 checks to see if an Internet connection exists for the Customer Computer 303. If no Internet connection exists, then in 1504, the Installer 350 causes the bundled promotional Media Object to be deployed so as to be played and/or displayed on the computer screen of the Customer Computer 303, and then continues on the next stage, as indicated by the letter C.

On the other hand, if an Internet connection is found in 1503, then in 1505, the Installer 350 initiates a connection with the Exchange Interface Program 330 on the Exchange Server 302 so that the Exchange Interface Program 330 may perform the method described in reference to FIG. 17, with the cooperation of the Installer, to determine whether the bundled promotional Media Object needs to be replaced. If the bundled promotional Media Object does not need replacement, then an indication to that effect is received from the Exchange Interface Program 330, and in 1506, the received indication causes the Installer 350 to proceed to 1504, so that the Installer 350 causes the bundled promotional Media Object to be played or displayed on the computer screen of the Customer Computer 303, and then continues on the next stage, as indicated by the letter C.

If, however, the bundled promotional Media Object does need replacement, then a replacement promotional Media Object is received from the Exchange Interface Program 330, and in 1506, the received replacement promotional Media Object causes the Installer 350 to proceed to 1507, so that the Installer 350 causes the replacement promotional Media Object to be played or displayed on the computer screen of the Customer Computer 303, and then continues on the next stage, as indicated by the letter C.

Referring now to FIG. 16, in 1601, the Installer 350 then looks to see if a promotional Media Object is referenced somewhere in the Installation Package 320. If no promotional Media Object reference is found, then in 1606, the method proceeds with the installation of the Host Application. Alternatively, if a promotional Media Object reference is found, then in 1602, the Installer 350 checks to see if an Internet connection exists for the Customer Computer 303. If no Internet connection exists, then the method proceeds to 1606.

On the other hand, if an Internet connection is found in 1602, then in 1603, the Installer 350 initiates a connection with the Exchange Interface Program 330 on the Exchange Server 302 so that the Exchange Interface Program 330 may perform the method described in reference to FIG. 17, with the cooperation of the Installer 350, to determine whether the referenced promotional Media Object is to be downloaded from the Exchange Interface Program 330, or a replacement for the referenced promotional Media Object should be downloaded instead. In any event, in 1604, a promotional Media Object is received from the Exchange Interface Program 330, and in 1605, the Installer 350 plays or displays the promotional Media Object on the computer screen of the Customer Computer 303, and then proceeds to 1606 to continue installation of the Host Application.

FIG. 17 illustrates, as an example, a method performed by the Exchange Interface Program 330 as it communicates and cooperates with the Installer 350 on the Customer Computer 303 to perform the tasks as described in reference to 1305 of FIG. 13, 1403 of FIG. 14, 1505 of FIG. 15, and 1603 of FIG. 16. In 1701, the Installer 350 connects with the Exchange Interface Program 330, using address information stored in either the Installer 350 or the Installation Package 320, and in 1702, the two programs perform a conventional AKE, using key information stored in the either the Installer 350 or Installation Package 320, to authenticate each other and establish a secure channel for communications.

In 1703, the Exchange Interface Program 330 receives information of a bundled Payload Application, a reference to a Payload Application, a bundled promotional Media Object, or a reference to a promotional Media Object, depending upon which of the tasks as described in reference to 1305, 1403, 1505, and 1603 it is performing.

In 1704, the Exchange Interface Program 330 determines if the bundled or referenced Payload Application, or the bundled or referenced promotional Media Object, is to be replaced with an alternative Material. There are a number of reasons why Material may be replaced at this point. For example, the Installment Package 320 may be old, and a newer version of the Payload Application or promotional Media Object may be available. As another example, the Publisher of the Payload Application or the Advertiser sponsoring the promotional Media Object may no longer be a Participant in the Marketing Service for any one of a number of reasons, including non-payment of money owed and voluntary de-registration. As still another example, the Host Application Publisher may have deselected the Payload Application for any one of a number of reasons, and selected either another Payload Application to be distributed using its installation packages or decided to no longer deliver any Payload Applications. As yet another example, if a Publisher's or Advertiser's specified budget has been reached for distributing his or her Payload Application or promotional Media Object, then another Publisher's or Advertiser's Payload Application or promotional Media Object is distributed at that time, as determined by a next-in-line procedure specified by the Host Application Publisher.

In any event, the Participant Information database 331 preferably indicates the current Payload Application(s) and/or promotional Media Object(s) that are to be distributed using installation packages for the Host Application of the Host Application Publisher, and the Exchange Interface Program 330 reads and compares information stored therein with the information received from the Installer 350 to determine whether a replacement Material is required.

If the determination in 1704 is YES (i.e., replacement or updating of the bundled or referenced Material is required), then in 1705, the replacement Material is copied from either the Payload Applications database 332 or Promotional Media Objects database 333, as appropriate, and transmitted to the Installer 350 by the Exchange Interface Program 330. In 1706, the Exchange Interface Program 330 then disconnects with the Installer 350 on the Customer Computer 303 following the transmission of the Material.

On the other hand, if the determination in 1704 is NO (i.e., replacement or updating of the bundled or referenced Material is not required), then in 1707, the Exchange Interface Program 330 checks whether the Payload Application or promotional Media Object is referenced or bundled. If it is referenced (i.e., the determination in 1707 is YES), then the method proceeds to 1705, where the referenced Material is copied from either the Payload Applications database 332 or Promotional Media Objects database 333, as appropriate, and transmitted to the Installer 350 by the Exchange Interface Program 330 before disconnecting with it in 1706. Alternatively, if it is not referenced (i.e., the determination in 1707 is NO), then the method proceeds to 1708, where the Exchange Interface Program 330 transmits an indication that it is okay to install the trial version of the bundled Payload Application or play the bundled promotional Media Object, as appropriate, to the Installer 350 before disconnecting with it in 1706.

As is apparent from the description of FIGS. 13-17, the capability to reference. Material instead of having to bundle it in the installation package provides considerable advantages and flexibility in the Marketing Service. As high speed Internet connections become more and more common, referencing becomes a particularly appealing method for distributing trial versions of Payload Applications and promotional Media Objects using installation packages for Host Applications. The hybrid approach, however, may be the preferable way to distribute Material using installation packages, because it provides a default mechanism (i.e., using bundled Payload Applications and promotional Media Objects) when no Internet connection is available, while still providing most of the advantages of referencing the Material when an Internet connection is available

FIG. 18 illustrates, as an example, a method performed by the Bounty Accounting Program 336 in cooperation with the Installer 350 installing the installation package 320, or a wrap-around program, and the Exchange Interface Program 330, to update Participant accounts resulting from Payload Applications or promotional Media Objects being distributed using the Installation Package 320. The Installer 350, in this case, may be a specially adapted installer for performing the Bounty reporting functions, or it may comprise a wrap-around program associated with a standard installer wherein the installer is executed through the wrap-around program along with the Bounty reporting functions. Certain Bounty reporting activity may be required, however, when the Installer 350 is not operative. In that case, a wrap-around program associated with the trial and/or full versions of the Payload Application may be used to perform the Bounty reporting functions. When the user wants to execute the installer, trial or full version of the Payload Application, he or she executes the wrap-around program instead, which in turn, commands the desired program to run. The modules for installing the wrap-around programs are preferably included in the installation package along with those for the Host Application, Payload Application and promotional Media Objects, and installed by the installer. For convenience in the following description, however, only the Installer 350 will be referred to. However, it is to be understood that it may be a wrap-around program that is instead performing the function, depending upon whether the Installer 350 is operating at the time.

Whenever a Bounty-generating event takes place, in 1801, the Installer 350 connects with the Exchange Interface Program 330 over the Internet 340 using information stored in either the Installer 350 or the Installation Package 320, and in 1802, the two programs authenticate each other and establish a secure connection through an AKE procedure, with the Installer 350 using a key stored in the Installer 350 or the Installation Package 320.

In 1803, the Installer transmits either or both the Host Application name or the Host Application Publisher name to the Exchange Interface Program 330, and in 1804, the Installer 350 transmits if the Material being distributed is a Payload Application, the title of the Payload Application whose trial version is being offered for installation, installed, used for the first time, or converted to a fully licensed product, or whose maintenance subscription for such a fully licensed version is being renewed; and/or the Installer 350 transmits, if the Material being distributed is a promotional Media Object, the title of the promotional Media Object being played or displayed on the computer screen of the Installer's customer computer.

In 1805, the received information is provided to the Bounty Accounting Program 336, which calculates the appropriate amount that is to be debited to the Host Publisher's account (i.e., the amount owed to the Host Publisher), the amount credited to the Payload Publisher's or the promotional Media Object's Advertiser's account (i.e., the amount owed by the Payload Publisher or Advertiser), and the amount retained by the Marketing Service itself (which is generally a percentage of the Bounty, so that the amount debited to the Host Publisher's account is the Bounty less an agreed upon commission or percentage to the Marketing Service), and in 1806, the appropriate accounting records for the parties are updated in the Accounting database 334. The connection between the Installer 350 and the Exchange Interface Program 330 is released or disconnected in 1807 (which although shown as occurring after 1806, may also optionally occur at any time after 1804).

Although the above described method performed by the Bounty Accounting Program 336 is shown as a separately occurring transaction, it is to be appreciated that it may also take place in conjunction with other communications between the Installer 350 and the Exchange Interface Program 330, such as during the process described in reference to FIGS. 13-17 when the Bounty generating event is the offer to install a trial version of the Payload Application or a playing or displaying of the promotional Media Object on the computer screen of the Customer Computer 303.

Calculation of the Bounty in 1805 may be based upon simple fee structures as described, for example, in reference to FIGS. 6-12, or more complicated fee structures such as step pricing and one-time, periodic, or ongoing real-time Bounty auctioning, as well as accommodating Publisher and/or Advertiser budget constraints as mentioned herein. As can be appreciated, the Marketing Service described herein can accommodate virtually any type of Bounty scheme, and all such schemes within the context of such an electronic marketplace are fully contemplated as being within the scope of the present invention.

FIG. 19 illustrates, as an example, a block diagram of the Marketing Service with exemplary Participants and their Customers. As previously described, multiple Publisher Computers, 301-1, 301-2 and 301-N, may communicate over the Internet 340 with the Exchange Server 302 through their own copies of the Packaging Program 310, or through a web browser, or by other conventional means. Each of the Publishers may have their own Customers, such as Customers 303-1-1 through 303-1-X for Publisher 301-1, to which they provide installation packages for installing their Application(s). Although not shown, some customers may also be shared by different publishers.

If a Publisher wants to serve as a Host Publisher, it registers with the Exchange Server 302 to indicate that it is willing to distribute Promotions of other Participants to its Customers using its installation packages. In that case, the Host Publisher's Application is referred to as the Host Application since the installation packages for that Application are the ones being used for distributing the Promotions.

As an example, when the Publisher operating Publisher Computer 301-1 decides to serve as a Host Publisher, it registers with the Exchange Server 302 so that other Publishers, operating Publisher Computers 301-2 to 301-N, may elect to have trial versions of their Applications (referred to as Payload Applications in that case) bundled or referenced in its installation packages that it provides to its Customers, who are operating Customer Computers 303-1-1 to 303-1-X.

On the other hand, if the Publisher wants to participate as a Payload Publisher, it registers with the Exchange Server 302 to indicate that it would like have other Publishers distribute trial versions of its Application(s) to their Customers using their installation packages. In that case, the Payload Publisher's Application is referred to as the Payload Application since it is being bundled or referenced in the installation packages of another Application (which is referred to as the Host Application in that case).

As an example, if the Publisher operating Publisher Computer 301-1 also wants to participate as a Payload Publisher, it registers with the Exchange Server 302 so that any registered Host Publishers (who agree to distribute trial versions of Payload Applications), such as perhaps the Publisher operating Publisher Computer 301-2, may agree to distribute the Payload Publisher's Application (which this time is referred to as being the Payload Application) to its Customers, who are operating Customer Computers 303-2-1 to 303-2-Y.

If the Publisher 301-1 also wants to participate as an Advertiser, it registers with the Exchange Server 302 to indicate that it would like have other Publishers distribute its promotional Media Object, such as a video clip promoting its Application, to their Customers using their installation packages. In particular, the Publisher operating Publisher Computer 301-1 registers with the Exchange Server 302, in this case, so that any registered Host Publishers (who agree to distribute Media Objects), such as perhaps the Publisher operating Publisher Computer 301-2, may agree to distribute the Payload Publisher's Media object to its Customers, who are operating Customer Computers 303-2-1 to 303-2-Y.

Advertisers do not have to be Publishers to participate in the Marketing Service. For example, FIG. 19 shows an Advertiser operating an Advertiser Computer 1901, who participates by registering with the Exchange Server 302 using a web browser or other conventional means. In this case, it would not register through the Packaging Program 310 since it has no Application to package, and therefore has no need for a Packaging Program.

Although the various aspects of the present invention have been described with respect to a preferred embodiment, it will be understood that the invention is entitled to full protection within the full scope of the appended claims.

What is claimed is:

1. A method for providing a marketplace in which publishers of host applications and promoters of promotions arrange for distribution of the promotions using installation packages for installing the host applications, comprising:
receiving information of bounties to be paid by the promoters for distribution of the promotions using the installation packages;
providing at least a portion of the information of bounties to one or more of the publishers; and
receiving from at least one of the one or more of the publishers, an indication of one or more of the promotions that the at least one of the one or more of the publishers is willing to allow to be distributed using the installation packages of the host applications for installing the at least one of the one or more of the publishers.

2. The method according to claim 1, wherein the method is performed by an exchange interface program residing on an exchange server, the installation packages are generated using packaging programs residing on publisher computers, and the exchange interface program communicates with the packaging programs to receive and provide the information of bounties from and to the publishers.

3. The method according to claim 2, wherein the installation packages are provided to customer computers for installation of the host applications on the customer computers.

4. The method according to claim 3, wherein the promotions include payload applications bundled with the host applications in the installation packages.

5. The method according to claim 3, wherein the promotions include payload applications referenced in the installation packages.

6. The method according to claim 5, wherein installers reside on the customer computers to install the host applications on the customer computers from the installation packages, and the method further comprises:
receiving information of the payload applications referenced in the installation packages from the installers; and
providing the referenced payload applications back to the installers from which the information of the payload applications was received.

7. The method according to claim 1, wherein the providing of the at least a portion of the information of bounties to one or more of the publishers, comprises:
receiving a list of acceptable publishers from the one or more of the publishers; and
providing the at least a portion of the information of bounties to the one or more publishers according to the list of acceptable publishers.

8. The method according to claim 1, wherein the providing of the at least a portion of the information of bounties to one or more of the publishers, comprises:
receiving a list of acceptable application categories from the one or more of the publishers; and
providing the at least a portion of the information of bounties to the one or more publishers according to the list of acceptable application categories.

9. The method according to claim 1, further comprising:
receiving the promotions for distribution from the promoters; and
testing the promotions for unauthorized spyware.

10. The method according to claim 9, further comprising: testing the promotions for computer viruses.

11. The method according to claim 10, further comprising: providing a certification to the one or more publishers for individual of the promotions that pass testing for unauthorized spyware and computer viruses.

12. A method for providing a marketplace in which publishers of host applications and promoters of promotions arrange for distribution of the promotions using installation packages for installing the host applications, comprising:
providing a packaging program to a publisher for generating the installation packages for installing the host application of the publisher on customer computers;
communicating with the packaging program to provide bounty information to the publisher payable by promoters to the publisher for distributing promotions of the promoters in the installation packages;
communicating with the packaging program to receive an indication from the publisher indicating a selection of one or more of the promoters; and
communicating with the packaging program to provide corresponding promotions of the one or more promoters to the publisher for distribution in the installation packages.

13. The method according to claim 12, further comprising:
providing installer programs to the customer computers for installing the installation packages on the customer computers; and
communicating with the installer programs to receive bounty triggering information for bounties payable by the one or more promoters to the publisher for providing the corresponding promotions for distribution in the installation packages.

14. The method according to claim 13, further comprising:
communicating with the installer programs to receive identifications of the promotions included in the installation packages; and
communicating with the installer programs to replace the promotions if the identifications are on a replacement list.

15. A method for providing a marketplace in which publishers of host applications and promoters of promotions arrange for distribution of the promotions using installation packages for installing the host applications, comprising:
receiving information of a bounty triggering event for a promotion from an installer for installing a host application on a customer computer from contents of an installation package; and
updating accounts for a publisher of the host application and a promoter of the promotion to reflect a bounty corresponding to the bounty triggering event.

16. The method according to claim 15, wherein the bounty triggering event is the installation of the trial version of the payload application on the customer computer.

17. The method according to claim 15, wherein the bounty triggering event is a first use by an operator of the customer computer of the trial version of the payload application.

18. The method according to claim 17, wherein the first use is determined by a wrapper program through which the trial version of the payload application is executed by the operator of the customer computer.

19. The method according to claim 18, wherein the wrapper program is also bundled in the installation package along with the host application and the trial version of the payload application.

20. The method according to claim 15, wherein the bounty triggering event is a conversion of the trial version of the payload application to a revenue generating license of the payload application.

21. The method according to claim 20, wherein the bounty triggering event is a renewal of a maintenance subscription for the revenue generating license of the payload application.

22. The method according to claim 15, wherein the promotion is included in the installation package.

23. The method according to claim 22, wherein the promotion is a trial version of a payload application.

24. The method according to claim 22, wherein the promotion is a promotional media object to be played by a media player.

25. The method according to claim 15, wherein the promotion is referenced in the installation package, and further comprising:
receiving an identification of the promotion referenced in the installation package; and
providing the promotion to the installer prior to receiving the information of the bounty triggering event from the installer.

26. A method for providing a marketplace in which publishers of host applications and promoters of promotions arrange for distribution of the promotions using installation packages for installing the host applications, comprising:
receiving information of a promotion associated with an installation package from an installer during a process of installing a host application using the installation package;
determining whether the promotion is to be replaced with a different promotion; and
providing the different promotion to the installer if the promotion is to be replaced, or providing an indication to the installer that the promotion is to be promoted if the promotion is not to be replaced.

27. The method according to claim 26, wherein the promotion is bundled with the host application in the installation package.

28. The method according to claim 26, wherein the promotion is referenced in the installation package.

29. The method according to claim 28, wherein the providing of the indication to the installer that the promotion is to be promoted if the promotion is not to be replaced, comprises: providing the promotion to the installer if the promotion is not to be replaced.

30. The method according to claim 26, wherein the determining of whether the promotion is to be replaced with a different promotion comprises: checking whether the promotion is included in a replacement list.

31. The method according to claim 30, wherein the different promotion is for a different promoter than the promotion associated with the installation package.

32. The method according to claim 30, wherein the different promotion is an updated version of the promotion and is from the same promoter as the promotion associated with the installation package.

33. A method for providing a marketplace in which publishers of host applications and promoters of promotions arrange for distribution of the promotions using installation packages for installing the host applications, comprising:
receiving an indication that a trial version of a payload application is to be distributed using installation packages for host applications of host publishers;
receiving bounty information indicating what a payload publisher of the payload application is willing to pay to the host publishers to distribute the trial version of the payload application using the installation packages; and
transmitting the bounty information to an exchange server accessible to the host publishers so that individual of the host publishers may agree to distribute the trial version of the payload application in the installation packages to their customers.

34. The method according to claim 33, wherein the receiving an indication that a trial version of a payload application is to be distributed using installation packages for host applications of host publishers, comprises:
displaying a clickable symbol on a computer screen of a computer operated by the payload publisher with corresponding text indicating that clicking of the symbol indicates that the trial version of the payload application is to be distributed using the installation packages for the host applications; and
receiving an indication that the symbol has been clicked.

35. The method according to claim 33, wherein the receiving bounty information indicating what a payload publisher of the payload application is willing to pay to the host publishers to distribute the trial version of the payload application using the installation packages, comprises:
displaying a page with data providable parts on a computer screen of a computer operated by the payload publisher with corresponding text indicating that bounty information is to be provided in the data providable parts; and
receiving the bounty information provided in the data providable parts.

36. The method according to claim 35, wherein the data providable parts includes a part for providing a bounty amount that the payload publisher is willing to pay for each installation of the trial version of the payload application.

37. The method according to claim 35, wherein the data providable parts includes a part for providing a bounty amount that the payload publisher is willing to pay for each upgrade from a trial version to a revenue generating licensed version of the payload application.

38. The method according to claim 35, wherein the data providable parts includes a part for indicating which of the host publishers may distribute the trial version of the payload application.

39. The method according to claim 35, wherein the data providable parts include a part for indicating which of the host applications may the trial version of the payload application be bundled with in the installation packages.

40. The method according to claim 35, wherein the data providable parts include a part for indicating whether the trial version of the payload application may be distributed using installation packages of host applications which have not been certified as being spyware free.

41. A method for providing a marketplace in which publishers of host applications and promoters of promotions arrange for distribution of the promotions using installation packages for installing the host applications, comprising:
receiving an indication that a host publisher of a host application agrees to promote payload applications of payload publishers using installation packages for installing the host application on customer computers; and
receiving bounty information from an exchange server accessible to the host publisher and the payload publishers, indicating what the payload publishers are willing to pay to have their respective payload applications promoted using the installation packages.

42. The method according to claim 40, wherein the receiving an indication that a host publisher of a host application agrees to promote payload applications of payload publishers using installation packages for installing the host application on customer computers, comprises:
displaying a clickable symbol on a computer screen of a computer operated by the host publisher with corresponding text indicating that clicking of the symbol indicates agreement by the host publisher to promote payload applications of the payload publishers using the installation packages for installing the host application on customer computers; and
receiving an indication that the symbol has been clicked.

43. The method according to claim 41, wherein the receiving bounty information from an exchange server accessible to the host publisher and the payload publishers, indicating what the payload publishers are willing to pay to have their respective payload applications promoted using the installation packages, comprises:
displaying a page with data providable parts on a computer screen of a computer operated by the payload publisher with corresponding text indicating that bounty information is to be provided in the data providable parts; and
receiving the bounty information provided in the data providable parts.

44. The method according to claim 43, wherein the data providable parts includes a part for providing a minimum bounty amount that the host publisher is willing to accept for each installation of a trial version of a payload application distributed using the installation package of the host application.

45. The method according to claim 43, wherein the data providable parts includes a part for indicating which of the payload publishers are acceptable to the host publisher for distributing trial versions of the payload applications using the installation packages.

46. The method according to claim 43, wherein the data providable parts include a part for indicating which of the payload applications may the trial versions of the payload applications be distributed using the installation packages.

47. The method according to claim 43, wherein the data providable parts include a part for indicating whether the trial version of the payload applications need to be certified as being spyware free.

48. A method for providing a marketplace in which publishers of host applications and promoters of promotions arrange for distribution of the promotions using installation packages for installing the host applications, comprising:
finding a promotion in an installation package of a host application during an installation process of the host application on a customer computer;
connecting with an exchange server and transmitting information identifying the host application and the promotion to the exchange server; and
receiving an indication to promote the promotion or a new promotion from the exchange server.

49. The method according to claim 48, wherein the promotion is a trial version of a payload application bundled with the host application in the installation package.

50. The method according to claim 48, wherein the promotion is a reference to a trial version of a payload application.

51. The method according to claim 50, wherein the receiving of the indication to promote the promotion comprises receiving an installable copy of the trial version of the payload application from the exchange server.

52. The method according to claim 48, wherein the promotion is a promotional media object included in the installation package.

53. The method according to claim 48, wherein the promotion is a reference to a promotional media object.

54. The method according to claim 53, wherein the receiving of the indication to promote the promotion comprises receiving the promotional media object from the exchange server.

55. A method for providing a marketplace in which publishers of host applications and promoters of promotions arrange for distribution of the promotions using installation packages for installing the host applications, comprising:
installing a trial version of a payload application on a customer computer, wherein the trial version of the payload application is bundled with a host application in an installation package provided by a host application publisher; and
reporting a bounty triggering event for the trial version of the payload application to an exchange server so that an agreed upon bounty corresponding to the bounty triggering event is to be paid by a payload application publisher to the host application publisher.

56. The method according to claim 55, wherein the bounty triggering event is one of a group consisting of: the installation of the trial version of the payload application on the customer computer, a first use by an operator of the customer computer of the trial version of the payload application, a conversion of the trial version of the payload application to a revenue generating license of the payload application, and a renewal of a maintenance subscription for the revenue generating license of the payload application.

57. The method according to claim 56, wherein the first use is determined by a wrapper program through which the trial version of the payload application is executed by the operator of the customer computer.

58. The method according to claim 57, wherein the wrapper program is also bundled in the installation package along with the host application and the trial version of the payload application.
